(19) United States
(12) Patent Application Publication
(10) Pub. No.: US 2015/0346529 A1
(43) Pub. Date: Dec. 3, 2015

(54) LIQUID CRYSTAL DISPLAY AND METHOD OF MANUFACTURING THE SAME

(71) Applicant: Samsung Display Co., Ltd., Yongin-City (KR)

(72) Inventors: JeongMin Park, Seoul (KR); Ji-Hyun Kim, Suwon-si (KR); Sungkyun Park, Suwon-si (KR); Jung-Soo Lee, Seoul (KR); Jun Chun, Yongin-si (KR); Ki-Hyun Cho, Suwon-si (KR)

(21) Appl. No.: 14/674,752

(22) Filed: Mar. 31, 2015

(30) Foreign Application Priority Data
May 28, 2014 (KR) 10-2014-0064577

(51) Int. Cl. G02F 1/1368; G02F 1/1335; G02F 1/1333

(52) U.S. Cl. CPC G02F 1/1368; G02F 1/133345; G02F 1/133514; G02F 1/133512; G02F 1/133305; G02F 2001/133302

(57) ABSTRACT

A liquid crystal display (LCD) and a method of manufacturing the same are disclosed. In one aspect, the LCD comprises a first substrate, a second substrate facing the first substrate, and a liquid crystal layer interposed between the first and second substrates. The first substrate comprises a first insulating substrate, a thin film transistor (TFT) formed over the first insulating substrate and including a drain electrode, and an insulating layer covering the TFT and comprising upper and lower portions having different heights, wherein the insulating layer has an opening formed through the lower portion so as to expose the drain electrode. The first substrate also comprises a reference electrode formed over the insulating layer, an inter-insulating electrode covering the reference electrode, and a pixel electrode formed over the inter-insulating layer and electrically connected to the drain electrode through the opening.

### INCORPORATION BY REFERENCE TO ANY PRIORITY APPLICATIONS

This U.S. non-provisional patent application claims priority under 35 U.S.C. §119 of Korean Patent Application No. 10-2014-0064577, filed on May 28, 2014, the contents of which are hereby incorporated by reference in its entirety.

### BACKGROUND

1. Field

The described technology generally relates to a liquid crystal display and a method of manufacturing the same.

2. Description of the Related Technology

Liquid crystal displays (LCDs) display images using a liquid crystal layer. An LCD is classified as an in-plane switching (IPS) mode, a vertical alignment (VA) mode, and a plane-to-line switching (PLS) mode according to its driving mechanism.

The LCD drives the liquid crystal layer using a horizontal or vertical electric field to display the image. In particular, liquid crystal molecules of the liquid crystal layer, which are formed above electrodes, rotate substantially in parallel to a substrate of the LCD due to a strong fringe electric field in the PLS mode.

### SUMMARY OF CERTAIN INVENTIVE ASPECTS

One inventive aspect is a liquid crystal display that can overcome technical limitations in processes applied to manufacture a high resolution display panel.

Another aspect is a method of manufacturing the liquid crystal display.

Another aspect is a liquid crystal display including a first substrate, a second substrate facing the first substrate, and a liquid crystal layer interposed between the first substrate and the second substrate.

The first substrate includes a first insulating substrate, a thin film transistor formed on the first insulating substrate, an insulating layer that covers the thin film transistor, includes an upper portion and a lower portion distinct from the upper portion according to a height from the first insulating substrate, and includes an opening portion formed through a portion of the lower portion to expose a drain electrode of the thin film transistor, a reference electrode formed on the insulating layer, an inter-insulating electrode covering the reference electrode, and a pixel electrode formed on the inter-insulating layer to electrically connect to the drain electrode through the opening portion.

Another aspect is a method of manufacturing a liquid crystal display that comprises a first substrate, a second substrate facing the first substrate, and a liquid crystal layer interposed between the first and second substrates, including forming a first substrate. The first substrate is formed by forming a thin film transistor on a first insulating substrate, forming an organic insulating pattern that covers the thin film transistor and includes an upper portion and a lower portion distinct from the upper portion according to a height from the first insulating substrate, the lower portion being formed at least on a drain electrode of the thin film transistor, forming a reference electrode on the organic insulating pattern, etching the organic insulating pattern using the reference electrode as a mask to form an insulating layer including an opening portion formed therethrough to expose the drain electrode, forming an inter-insulating layer to cover the reference electrode, and forming a pixel electrode on the inter-insulating layer such that the pixel electrode is electrically connected to the drain electrode through the opening portion.

Another aspect is a liquid crystal display (LCD) comprising a first substrate, a second substrate facing the first substrate, and a liquid crystal layer interposed between the first and second substrates. The first substrate comprises a first insulating substrate, a thin film transistor (TFT) formed over the first insulating substrate and including a drain electrode, and an insulating layer covering the TFT and comprising upper and lower portions having different heights, wherein the insulating layer has an opening formed through the lower portion so as to expose the drain electrode. The first substrate also comprises a reference electrode formed over the insulating layer, an inter-insulating electrode covering the reference electrode, and a pixel electrode formed over the inter-insulating layer and electrically connected to the drain electrode through the opening.

In the above LCD, the reference electrode is further formed over the upper and lower portions. In the above LCD, the reference electrode exposes at least part of the drain electrode.

The above LCD further comprises a protective layer formed under the insulating layer so as to cover the TFT, wherein the protective layer comprises a first contact hole formed therethrough so as to expose at least part of the drain electrode.

In the above LCD, the inter-insulating layer substantially covers the reference electrode and has a second contact hole formed therethrough so as to expose the part of the drain electrode. In the above LCD, the second contact hole is further formed in the opening. In the above LCD, the second contact hole has a width less than that of the opening.

In the above LCD, the first contact hole has a width corresponding to the width of the second contact hole. In the above LCD, the width of the first contact hole corresponds to the width of the opening.

In the above LCD, the pixel electrode directly contacts the drain electrode through the first and second contact holes.

In the above LCD, the first substrate further comprises a color filter layer including a plurality of color pixels, and a black matrix formed between the color pixels, wherein the lower portion and opening are formed in an area in which the black matrix is formed when viewed in a plan view.

In the above LCD, the second substrate further comprises a second insulating substrate facing and connected to the first insulating substrate, a color filter layer formed over the second insulating substrate and including a plurality of color pixels, and a black matrix formed between the color pixels, wherein the lower portion and the opening are formed in an area in which the black matrix is formed when viewed in a plan view.

Another aspect is a method of manufacturing a liquid crystal display (LCD) that comprises a first substrate, a second substrate facing the first substrate, and a liquid crystal layer interposed therebetween. The method comprises forming a first substrate, comprising forming a thin film transistor (TFT) including a drain electrode on a first insulating substrate, forming an organic insulating pattern that i) covers the TFT and ii) comprises upper and lower portions having different heights, wherein the lower portion is formed at least over the drain electrode, forming a reference electrode over the organic insulating pattern, and etching the organic insulating pattern using the reference electrode as a mask so as to form an insulating layer having an opening formed therethrough, wherein the opening exposes the drain electrode. The forming the first substrate further comprises forming an inter-insulating layer so as to cover the reference electrode and forming a pixel electrode over the inter-insulating layer such that the pixel electrode is electrically connected to the drain electrode through the opening.

The above method further comprises forming a first inorganic insulating layer covering the TFT before forming the TFT. In the above method, the forming of the organic insulating pattern comprises forming a photosensitive organic insulating layer over the first inorganic insulating layer and patterning the photosensitive organic insulating layer through an exposure process using a halftone mask so as to form the organic insulating pattern including the upper and lower portions.

In the above method, the forming of the inter-insulating layer comprises forming a second inorganic insulating layer over the reference electrode and the organic insulating pattern, forming a photosensitive pattern having an opening hole formed therethrough on the second inorganic insulating layer, and etching the first and second inorganic insulating layers using the photosensitive pattern as a mask so as to form first and second contact holes respectively through the first and second inorganic insulating layers, wherein the first and second contact holes expose at least part of the drain electrode.

In the above method, the first inorganic insulating layer is etched so as to form a protective layer having a first contact hole formed therethrough, wherein the first contact hole corresponds to the opening when the organic insulating pattern is etched using the reference electrode as a mask.

In the above method, the forming of the inter-insulating layer comprises forming a second inorganic insulating layer over the reference electrode and the organic insulating pattern, forming a photosensitive pattern having an opening hole formed therethrough over the second inorganic insulating layer, and etching the second inorganic insulating layer using the photosensitive pattern as a mask so as to form a second contact hole through the second inorganic insulating layer such that at least part of the drain electrode is exposed through the second contact hole.

In the above method, the second contact hole is formed in the opening. In the above method, the second contact hole has a width less than the width of the opening.

According to at least one of the disclosed embodiments, the insulating layer includes the lower portion having the relatively small thickness in the area in which the thin film transistor area is formed, and thus the thickness of the photosensitive layer used to form the contact hole through the inter-insulating layer, through which the drain electrode is exposed can be reduced. Thus, a micro contact hole can be accurately formed and the degree of difficulty of the exposure process can be lowered.

### BRIEF DESCRIPTION OF THE DRAWINGS

FIG. 1 is a block diagram showing a liquid crystal display according to an exemplary embodiment.

FIG. 2 is an equivalent circuit diagram showing a pixel shown in FIG. 1.

FIG. 3 is a plan view showing a liquid crystal display panel shown in FIG. 2.

FIG. 4 is a cross-sectional view taken along a line I-I′ shown in FIG. 3.

FIG. 5 is a plan view showing an organic insulating layer shown in FIG. 4.

FIGS. 6A to 6H are cross-sectional views showing a manufacturing method of a first substrate shown in FIG. 4.

FIG. 7 is a cross-sectional view showing a liquid crystal display panel according to another exemplary embodiment.

FIGS. 8A to 8F are cross-sectional views showing a manufacturing method of a first substrate shown in FIG. 7.

### DETAILED DESCRIPTION OF CERTAIN INVENTIVE EMBODIMENTS

It will be understood that when an element or layer is referred to as being “on”, “connected to” or “coupled to” another element or layer, it can be directly on, connected or coupled to the other element or layer or intervening elements or layers can be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. can be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the described technology.

Spatially relative terms, such as “beneath”, “below”, “lower”, “above”, “upper” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device can be otherwise oriented (rotated 90 degrees or at other orientations) and the spatially relative descriptors used herein interpreted accordingly.

The terminology used herein is for the purpose of describing particular embodiments only and is not intended to be limiting of the described technology. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the described technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

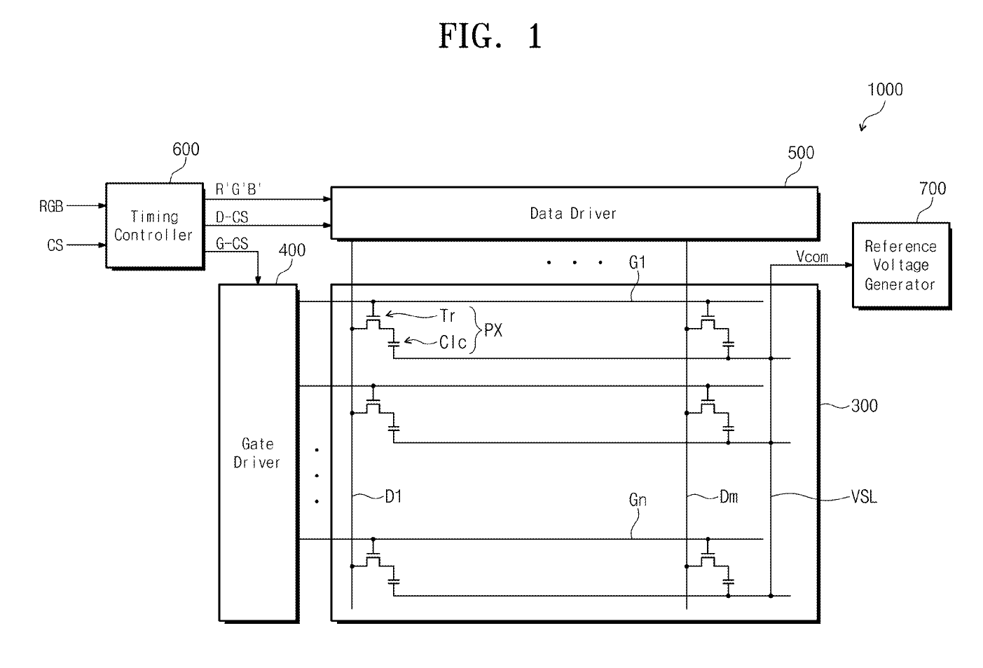

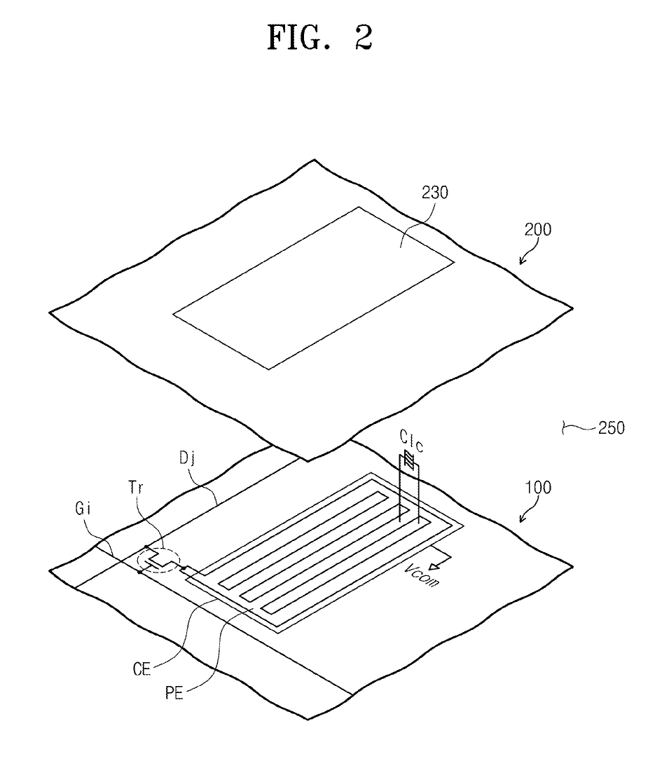

FIG. 1 is a block diagram showing a liquid crystal display (LCD) 1000 according to an exemplary embodiment. FIG. 2 shows a substantially equivalent circuit diagram of the LCD 1000 driven in a plane-to-line switching (PLS) mode.

Referring to FIG. 1, the LCD 1000 includes an image display portion 300 to display an image, gate and data drivers 400 and 500 to drive the image display portion 300, and a timing controller 600 to control the gate and data drivers 400 and 500.

The image display portion 300 includes a plurality of gate lines G1 to Gn, a plurality of data lines D1 to Dm, and a plurality of pixels PX. As shown in FIG. 2, the image display portion 300 includes a first substrate 100, a second substrate 200 facing the first substrate 100, and a liquid crystal layer 250 interposed therebetween.

The gate lines G1 to Gn and the data lines D1 to Dm are formed on the first substrate 100. The gate lines G1 to Gn extend in a row direction and are arranged substantially parallel to each other. The data lines D1 to Dm extend in the column direction and are arranged substantially parallel to each other.

Each pixel PX includes a thin film transistor and a liquid crystal capacitor. Since each of the pixels PX has substantially the same structure and function, only one pixel PX will be described in detail. For instance, the pixel connected to an i-th (“i” is an integer number equal to or greater than 1) gate line Gi and a j-th (“j” is an integer number equal to or greater than 1) data line Dj includes the thin film transistor Tr and the liquid crystal capacitor Clc.

The thin film transistor Tr includes a gate electrode connected to the i-th gate line Gi, a source electrode connected to the j-th data line Dj, and a drain electrode connected to the liquid crystal capacitor Clc.

The liquid crystal capacitor Clc includes a pixel electrode PE and a reference electrode CE, which are formed on the first substrate 100, as its two terminals. The liquid crystal layer 250 serves as a dielectric substance. The pixel electrode PE is electrically connected to the drain electrode of the thin film transistor Tr and the reference electrode CE receives a reference voltage Vcom from a reference voltage generator 700.

Each pixel PX includes a color filter layer 230 formed on the second substrate 200 corresponding to the pixel electrode PE so as to represent one of primary colors. Different from FIG. 2, the color filter layer 230 can be formed on or under the pixel electrode PE.

Referring to FIG. 1 again, the timing controller 600 receives a plurality of image signals RGB and a plurality of control signals CS from the outside of the LCD 1000. The timing controller 600 converts a data format of the image signals RGB to a data format appropriate to an interface between the data driver 500 and the timing controller 600. Then, the timing controller 600 applies the converted image signals R′G′B′ to the data driver 500. The timing controller 600 generates a data control signal D-CS (e.g., an output start signal, a horizontal start signal, etc.) and a gate control signal G-CS (e.g., a vertical start signal, a vertical clock signal, a vertical clock bar signal, etc.) based at least in part on the control signals CS. The data control signal D-CS is applied to the data driver 500 and the gate control signal G-CS is applied to the gate driver 400.

The gate driver 400 sequentially outputs gate signals based at least in part on the gate control signal G-CS provided from the timing controller 600. Accordingly, the pixels PX are sequentially scanned by the gate signals.

The data driver 500 converts the image signals R′G′B′ provided from the timing controller 600 to data voltages, which are applied to the image display portion 300.

Therefore, each pixel PX is turned on based at least in part on a corresponding gate signal of the gate signals, and the turned-on pixel PX is applied with a corresponding data voltage of the data voltages from the data driver 500, thereby displaying the image at a desired grayscale.

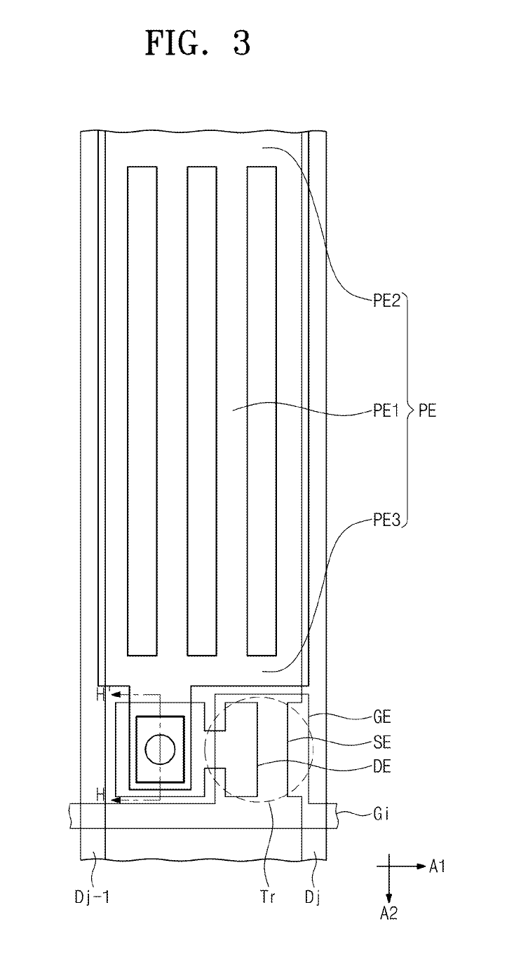

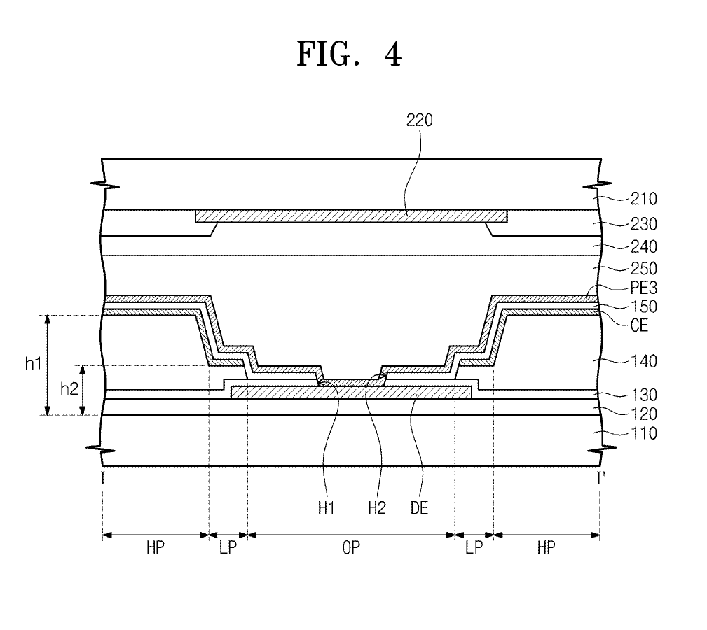

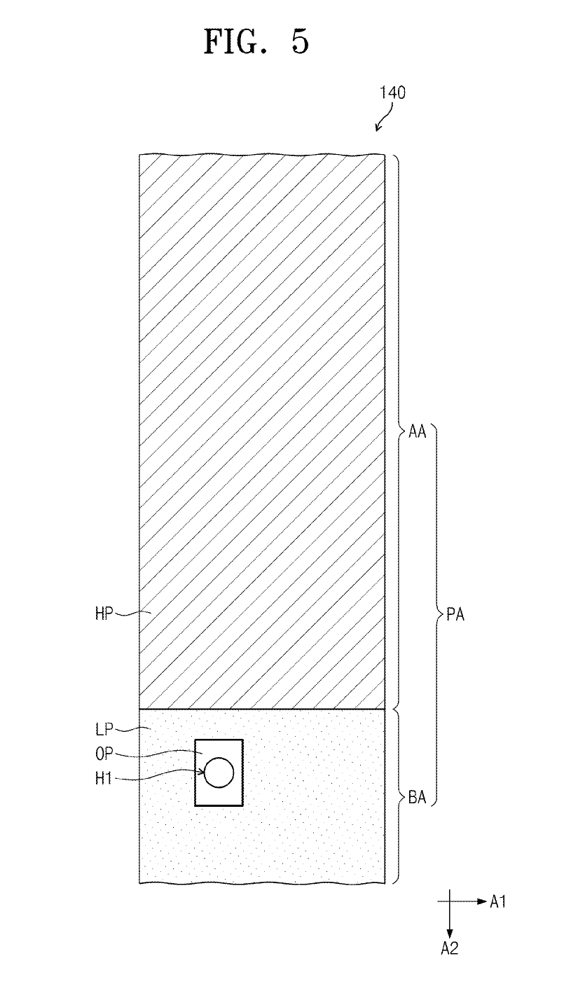

FIG. 3 is a plan view showing the LCD panel 1000 shown in FIG. 2. FIG. 4 is a cross-sectional view taken along a line I-I′ shown in FIG. 3. FIG. 5 is a plan view showing the organic insulating layer shown in FIG. 4.

Referring to FIGS. 3 and 4, the image display portion 300 (hereinafter, referred to as LCD panel) includes the first substrate 100, the second substrate 200 facing the first substrate 100, and the liquid crystal layer 250 interposed therebetween.

The first substrate 100 includes a first insulating substrate 110 formed of a transparent glass or plastic. The first substrate 100 also includes the i-th gate line Gi, (j−1)th data line Dj−1, and the j-th data line Dj, which are formed on the first insulating substrate 110.

The i-th gate line Gi extends in a first direction A1. The (j−1)th and j-th data lines Dj−1 and Dj extend in a second direction A2 crossing the first direction A1. The (j−1)th and j-th data lines Dj−1 and Dj are spaced apart from each other in the first direction A1 by a predetermined distance.

The i-th gate line Gi is electrically insulated from the (j−1)th and j-th data lines Dj−1 and Dj by a gate insulating layer 120. The (j−1)th and j-th data lines Dj−1 and Dj are at least partially covered by a protective layer 130. As an example, the protective layer 130 includes an inorganic insulating layer formed of silicon nitride (SiNx) or silicon oxide (SiOx). In addition, the protective layer 130 can have a single-layer structure of silicon nitride (SiNx) or silicon oxide (SiOx), but it is not be limited thereto or thereby. According to some embodiments, the protective layer 130 can have a double-layer structure of upper and lower layers, which are respectively formed of silicon nitride (SiNx) or silicon oxide (SiOx).

An organic insulating layer 140 is formed on the protective layer 130. The organic insulating layer 140 can be formed of an acryl-based resin.

In addition, the thin film transistor Tr, the pixel electrode PE, and the reference electrode CE are formed on the first insulating substrate 110. In detail, the thin film transistor Tr includes the gate electrode GE corresponding to a portion of the i-th gate line Gi and the source electrode SE corresponding to a portion of the j-th data line Dj. The thin film transistor Tr also includes the drain electrode DE formed on the gate electrode GE and spaced apart from the source electrode SE by the predetermined distance. The drain electrode DE is electrically connected to the pixel electrode PE.

The pixel electrode PE includes a plurality of branch electrodes PE1, a first connection electrode PE2 to connect first ends of the branch electrodes PE1 to each other, and a second connection electrode PE3 so as to connect second ends of the branch electrodes PE1 to each other. The branch electrodes PE1 extend in the second direction A2 and are arranged in the first direction A1. The first and second connection electrodes PE2 and PE3 extend in the first direction A1. In addition, a portion of the second connection electrode PE3 extends in the second direction A2 so as to at least partially overlap with the drain electrode DE.

The protective layer 130 includes a first contact hole H1 formed therethrough so as to expose a portion of the drain electrode DE. The organic insulating layer 140 is formed on the protective layer 130.

Referring to FIGS. 4 and 5, the organic insulating layer 140 includes an upper portion HP, a lower portion LP, and an opening portion OP. A top surface of the upper portion HP is located at a first height h1 measured from the first insulating substrate 110 and a top surface of the lower portion LP is located at a second height h2 measured from the first insulating substrate 110. The first height h1 is greater than the second height h2. The opening portion OP is formed so as to expose the drain electrode DE.

As shown in FIG. 5, a pixel area PA includes an effective area AA and a block area BA. The effective area AA transmits a light traveling thereto and the block area BA blocks the light using a black matrix 220. Although not shown in figures, a vertical block area can be further formed along the (j−1)th and j-th data lines Dj−1 and Dj.

The upper portion HP of the organic insulating layer 140 is formed in the effective area AA, and although not shown in the figures, the upper portion HP of the organic insulating layer 140 can be further formed in the vertical block area.

In FIG. 5, the opening portion OP has a substantially quadrangular shape when viewed in a plan view, but the shape of the opening portion OP is not limited thereto.

The reference electrode CE is formed on or under the pixel electrode PE. As shown in FIG. 4, the reference electrode CE is formed on the organic insulating layer 140 and substantially covered by an inter-insulating layer 150. The pixel electrode PE is formed on the inter-insulating layer 150. As described above, the reference electrode CE is formed under the pixel electrode PE and faces the pixel electrode PE, but the reference electrode CE is electrically insulated from the pixel electrode CE by the inter-insulating layer 150 formed between the reference electrode CE and the pixel electrode PE.

The inter-insulating layer 150 includes a second contact hole H2 formed therethrough to correspond to the first contact hole H1, and thus the drain electrode DE exposed through the first contact hole H1 is exposed through the second contact hole H2. Thus, the second connection electrode PE3 directly contacts the drain electrode DE through the first and second contact holes H1 and H2.

The first and second contact holes H1 and H2 are formed in the area in which the opening portion OP is formed and have a size smaller than that of the opening portion OP.

Meanwhile, the reference electrode CE of each pixel PX is electrically connected to a reference electrode formed in the same row and adjacent thereto so to form a reference electrode row. The reference electrode row is electrically connected to a reference voltage supply line VSL (refer to FIG. 1) at one end portion of the first substrate 100. The reference electrode row receives the reference voltage Vcom from the reference voltage generator 700 (refer to FIG. 1).

Referring to FIG. 4 again, the second substrate 200 includes a second insulating substrate 210 formed of a transparent glass or plastic. The color filter layer 230, which can include plural color pixels, is formed on the second insulating substrate 210, and the black matrix 220 is formed between two adjacent color pixels. The black matrix 220 is formed of a light blocking material, e.g., an organic material BM, chromium (Cr), etc. An overcoating layer 240 is formed on the black matrix 220 and the color filter layer 230 so as to planarize an upper surface of the second substrate 200. The overcoating layer 240 can be formed of an organic insulating material.

The opening portion OP is surrounded by the lower portion LP. The lower portion LP and the opening portion OP are formed so as to correspond to the block area BA in which the black matrix 220 is formed.

The second substrate 200 faces the first substrate 100 while being coupled to the first substrate 100 and the liquid crystal layer 250 is interposed between the first and second substrates 100 and 200.

When the gate signal is applied to the pixel PX through the i-th gate line Gi, the thin film transistor Tr is turned on based at least in part on the gate signal. The data voltage applied to the j-th data line Dj is output from the drain electrode DE and applied to the pixel electrode PE.

The pixel electrode PE applied with the data voltage forms an electric field with the reference electrode CE applied with the reference voltage Vcom so as to determine an alignment direction of the liquid crystal molecules. The light incident to and transmitting through the liquid crystal layer 250 is polarized by the liquid crystal molecules aligned in a specific direction.

The pixel electrode PE and the reference electrode CE form the liquid crystal capacitor Clc (refer to FIG. 1), which includes the liquid crystal layer 250 as the dielectric substance, so as to maintain the voltage applied to the pixel electrode PE after the thin film transistor Tr is turned off.

Although not shown in figures, each pixel PX can further include a storage line overlapped with the pixel electrode PE. The storage line and the pixel electrode PE form a storage capacitor using the gate insulating layer 120, the protective layer 130, and the inter-insulating layer 140 as its dielectric substance. The voltage maintaining ability of the liquid crystal capacitor Clc can be enhanced.

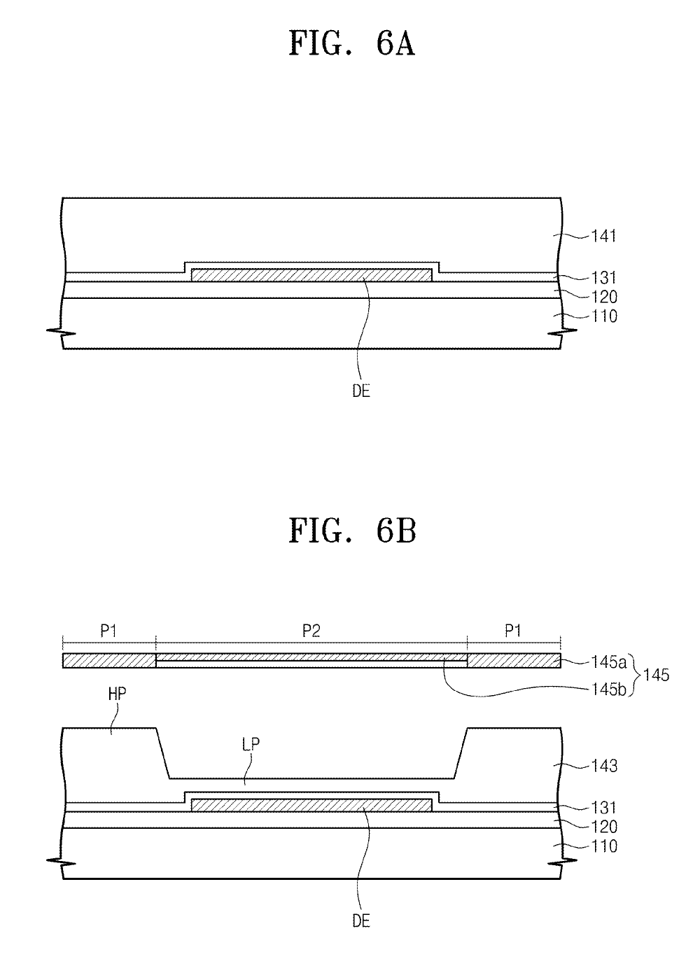

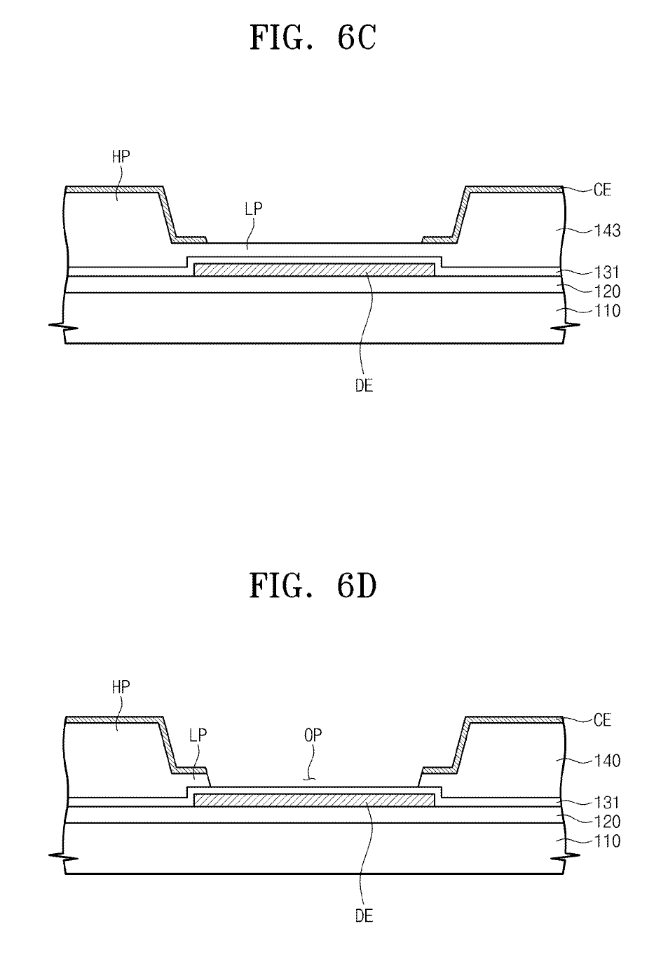

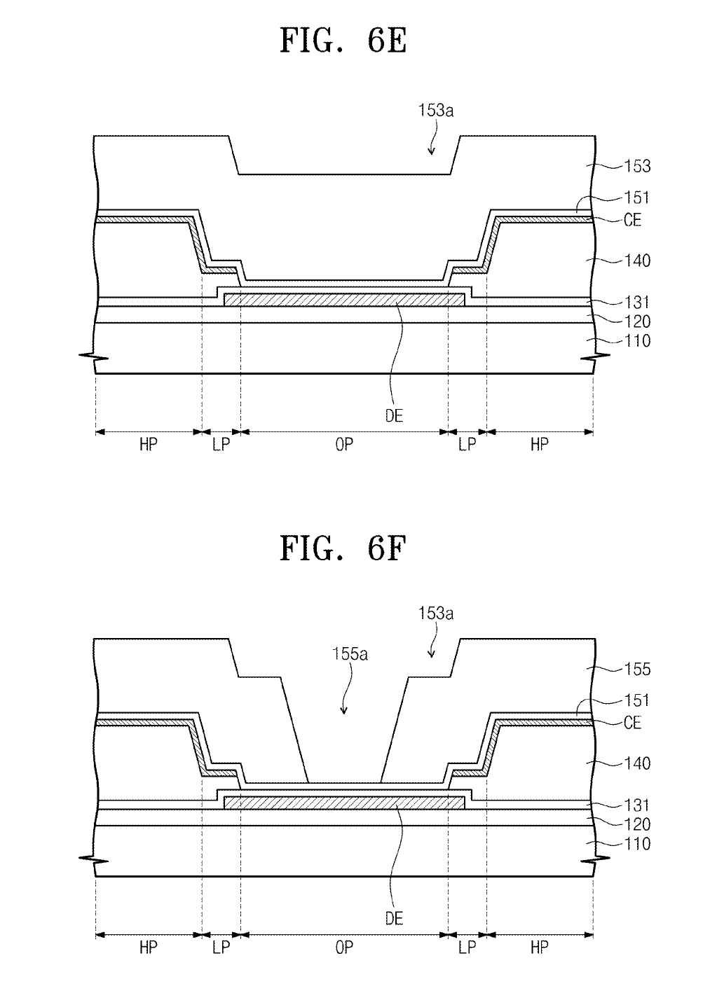

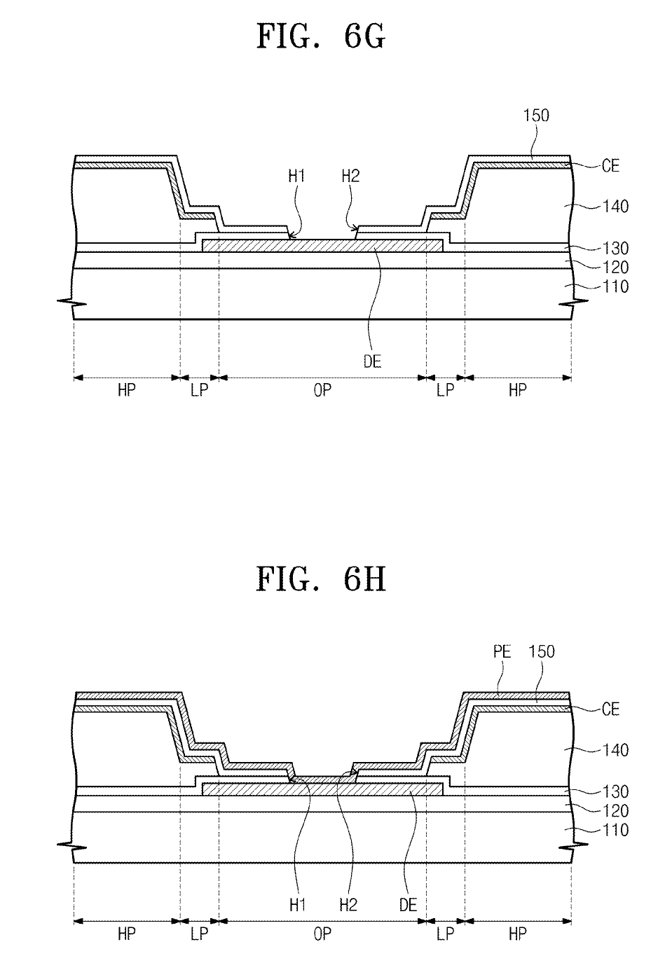

FIGS. 6A to 6H are cross-sectional views showing a manufacturing method of the first substrate shown in FIG. 4. In detail, processes of forming the organic insulating layer 140 and the pixel electrode PE on the first substrate 100 will be mainly described with reference to FIGS. 6A to 6H.

Referring to FIG. 6A, the gate insulating layer 120 and the drain electrode DE are formed on the first insulating substrate 110. The gate insulating layer 120 can be formed of silicon nitride (SiNx) or silicon oxide (SiOx).

Then, a first inorganic insulating layer 131 is formed so as to cover the drain electrode DE. An organic insulating material 141 is formed on the first inorganic insulating layer 131. The organic insulating material 141 can be formed of an acryl-based resin with photosensitivity.

Referring to FIG. 6B, a halftone mask 145 is formed above the organic insulating material 141. The halftone mask 145 includes a light blocking pattern 145a in a first area P1 and a half exposure pattern 145b in a second area P2. Here, the organic insulating material 141 can be a positive-type photosensitive material, but is not limited thereto. However, when the organic insulating material 141 includes a negative-type photosensitive material, an opening pattern can be formed instead of the light blocking pattern 134a so as to perform full exposure.

When the organic insulating material 141 is exposed to light through the halftone mask 145 and developed, an organic insulating pattern 143 including the upper portion HP formed in the first area P1 and the lower portion LP formed in the second area P2 is formed.

Referring to FIG. 6C, a first transparent conductive layer is formed on the organic insulating pattern 143. The first transparent conductive layer can be formed of a transparent conductive material, e.g., indium tin oxide. The first transparent conductive layer is patterned so as to form the reference electrode CE. End portions of the reference electrode CE extend to the upper surface of the lower portion LP. In addition, the reference electrode CE can be partially opened so as to expose a portion of the lower portion LP.

Referring to FIG. 6D, the portion of the lower portion LP is etched using the reference electrode CE as a mask. Accordingly, the lower portion LP is partially opened and the opening portion OP is formed through the organic insulating layer 140.

Referring to FIG. 6E, a second inorganic insulating layer 151 is formed on the organic insulating layer 140 and a photosensitive layer 153 is formed on the second inorganic insulating layer 151.

A step-difference portion 153a is formed due to a step difference between the upper and lower portions HP and LP. The height of the photosensitive layer 153 from the first insulating substrate 110 is reduced in the step-difference portion 153a. The height reduction is the difference in height between the upper portion HP and the lower portion LP in the step-difference portion 153a. Therefore, when the thickness of the photosensitive layer 153 is reduced in the step-difference portion 153a, a resolving power of the photosensitive layer 153 is increased. The resolving power of the photosensitive layer 153 is based at least in part by the thickness of the photosensitive layer 153. Thus, when the lower portion LP expands to the effective area AA, the thickness of the photosensitive layer 153 can be more reduced in the step-difference portion 153a. However, when the lower portion LP expands to the effective area AA, a cell gap uniformity of the effective area AA deteriorates. Accordingly, the lower portion LP is formed in the block area BA.

Referring to FIG. 6F, an opening hole 155a is formed through the step-difference portion 153a through an exposure process so as to expose the second inorganic insulating layer 151. When the first and second inorganic insulating layers 141 and 151 are etched using a photosensitive pattern 155 having the opening hole 155a, the inter-insulating layer 150 and the protective layer 130 are formed as shown in FIG. 6G. The portion of the drain electrode DE is exposed through the first and second contact holes H1 and H2. Then, the photosensitive pattern 155 is removed from the inter-insulating layer 150 through a strip process.

Referring to FIG. 6H, a second transparent conductive layer is formed on the inter-insulating layer 150. The second transparent conductive layer can be formed of a transparent conductive material, e.g., indium tin oxide, indium zinc oxide, etc. The second transparent conductive layer is patterned through a patterning process, and thus the pixel electrode PE is formed on the inter-insulating layer 150. The pixel electrode PE contacts the drain electrode DE through the first and second contact holes H1 and H2.

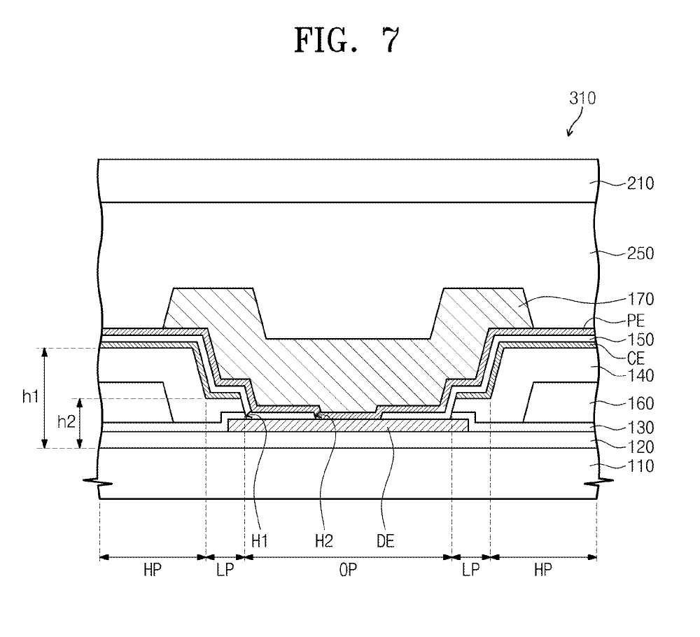

FIG. 7 is a cross-sectional view showing a LCD panel 310 according to another exemplary embodiment. In FIG. 7, the same reference numerals denote the same elements in FIG. 4, and thus detailed descriptions of the same elements will be omitted.

Referring to FIG. 7, the LCD panel 310 includes a first substrate 100, a second substrate 200 facing the first substrate 100, and a liquid crystal layer 250 interposed therebetween.

The first substrate 100 further includes a color filter layer 160 formed on the protective layer 130 and a black matrix 170 formed on the pixel electrode PE or the inter-insulating layer 150.

The color filter layer 160 includes red, green, and blue color pixels. A side surface and an upper surface of the color filter layer 160 are wholly covered by the organic insulating layer 140.

The organic insulating layer 140 includes an upper portion HP, a lower portion LP, and an opening portion OP. The upper portion HP is located at a first height h1 from the first insulating substrate 110 and the lower portion LP is located at a second height h2 lower than the first height from the first insulating substrate 110. The opening portion OP is formed to expose the drain electrode DE.

Here, a first contact hole H1 is formed through the protective layer 130 so as to have a size and a width corresponding to that of the opening portion OP. An upper surface of the drain electrode DE is exposed through the first contact hole H1.

The reference electrode CE is formed on the organic insulating layer 140 and at least partially covered by the inter-insulating layer 150. The reference electrode CE is removed from an area corresponding to the opening portion OP.

The inter-insulating layer 150 extends to the opening portion OP and is formed on the upper surface of the drain electrode DE. The inter-insulating layer 150 includes a second contact hole H2 formed therethrough to partially expose the upper surface of the drain electrode DE. The second contact hole H2 is formed in the opening portion OP and has a size and a width smaller than the opening portion OP.

The pixel electrode PE is formed on the inter-insulating layer 150 and directly contacts the drain electrode DE through the second contact hole H2. As described above, the reference electrode CE is formed under the pixel electrode PE and faces the pixel electrode PE while being electrically insulated from the pixel electrode PE by the inter-insulating layer 150.

The black matrix 170 is formed on the pixel electrode PE. The black matrix 170 can be formed of the organic material BM.

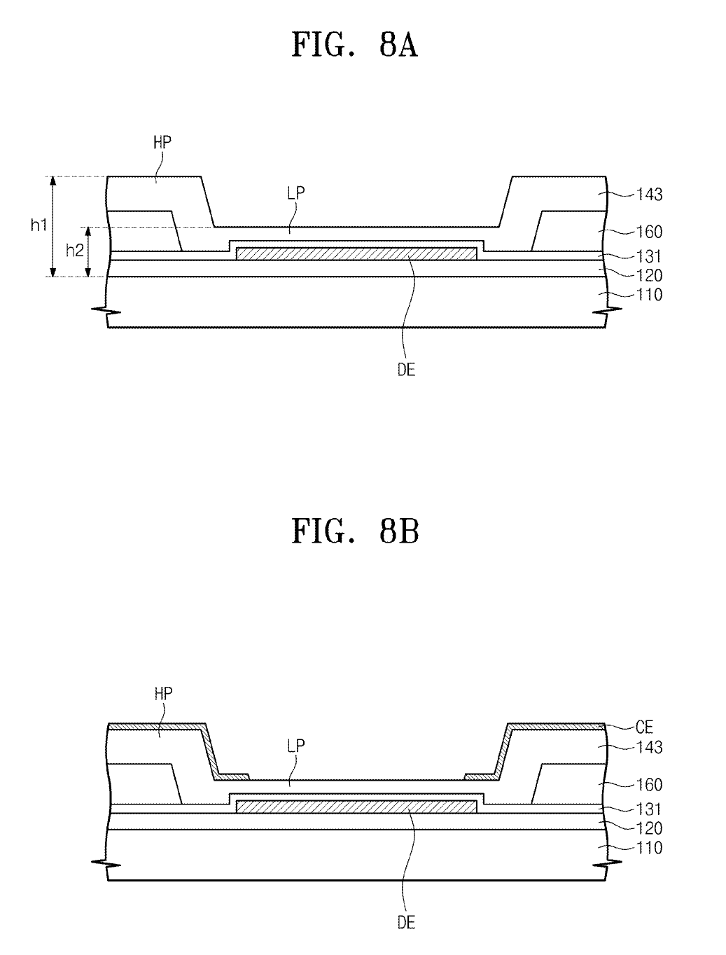

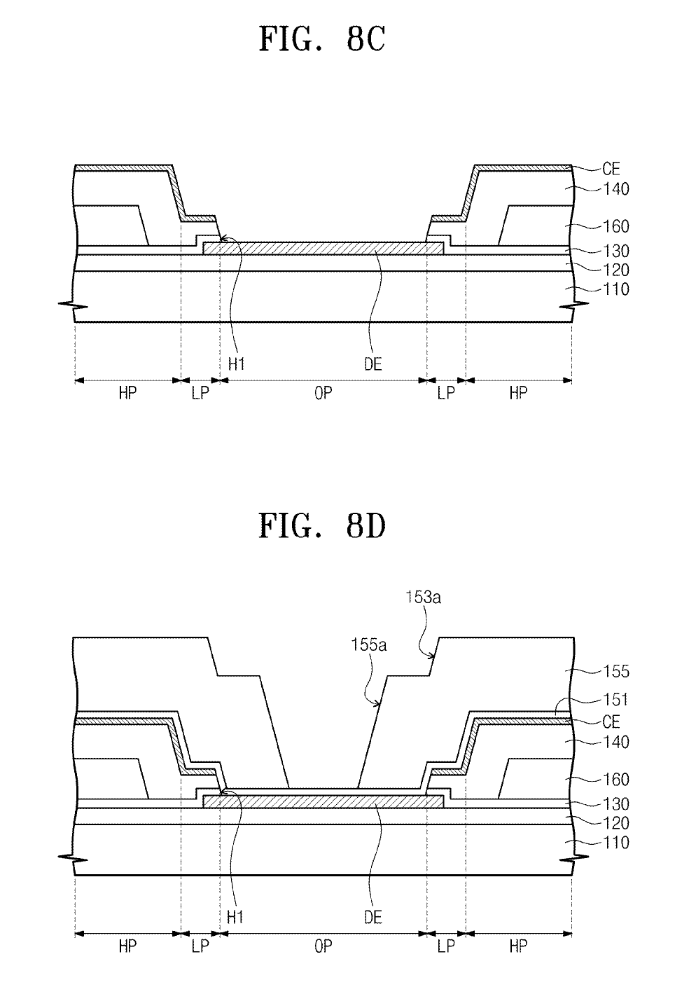

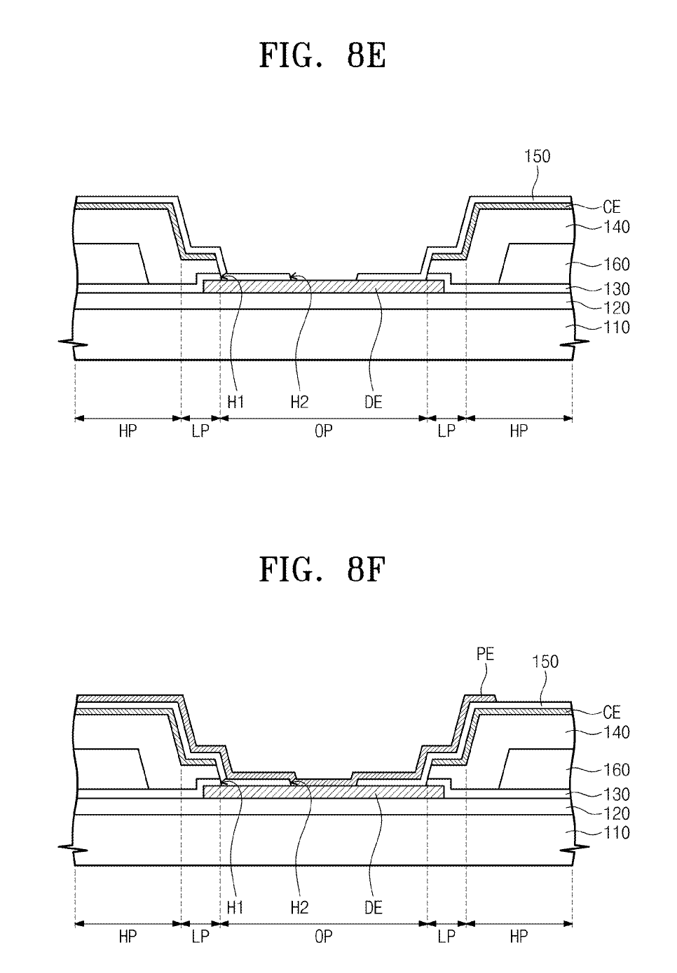

FIGS. 8A to 8F are cross-sectional views showing a manufacturing method of the first substrate shown in FIG. 7.

Referring to FIG. 8A, the gate insulating layer 120 and the drain electrode DE are formed on the first insulating substrate 110. A first inorganic insulating layer 131 is formed so as to cover the drain electrode DE and an organic insulating pattern 143 is formed on the first inorganic insulating layer 131. The organic insulating pattern 143 can be formed of an acryl-based resin.

The organic insulating pattern 143 includes an upper portion HP and a lower portion LP. A top surface of the upper portion HP is located at a first height H1 measured from the first insulating substrate 110 and a top surface of the lower portion LP is located at a second height H2 measured from the first insulating substrate 110. The second height H2 can be controlled in the exposure process applied to form the organic insulating pattern 143.

Referring to FIG. 8B, a first transparent conductive layer is formed on the organic insulating pattern 143. The first transparent conductive layer is patterned so as to form the reference electrode CE. End portions of the reference electrode CE extend to the upper surface of the lower portion LP. In addition, the reference electrode CE can be opened so as to expose the portion of the lower portion LP of the organic insulating pattern 143.

Referring to FIG. 8C, the lower portion LP of the organic insulating pattern 143 is partially etched using the reference electrode CE as a mask. Accordingly, the portion of the lower portion LP is opened, and thus the opening portion OP is formed through the organic insulating layer 140.

When an etchant that substantially simultaneously etches the first inorganic insulating layer 131 and the organic insulating pattern 143 is used during the etch process, the first inorganic insulating layer 131 can be additionally etched. In this case, during one etch process, the opening portion OP is formed through the organic insulating layer 140, and substantially simultaneously, the first contact hole H1 is formed through the protective layer 130. Therefore, the first contact hole H1 can have the size and the width corresponding to that of the opening portion OP.

Referring to FIG. 8D, a second inorganic insulating layer 151 is formed on the reference electrode CE and a photosensitive pattern 155 is formed on the second inorganic insulating layer 151.

A step-difference portion 153a is formed in the photosensitive pattern 155 due to the step difference between the upper portion HP and the lower portion LP. An opening hole 155b is formed in the step-difference portion 153a so as to expose the second inorganic insulating layer 151. When the second inorganic insulating layer 151 is etched using the photosensitive pattern 155 having the opening hole 155b, the inter-insulating layer 150 through which the second contact hole H2 is formed is formed as shown in FIG. 8E.

Here, the size and width of the second contact hole H2 is smaller than the size and width of the first contact hole H1 and the opening portion OP. Thus, an end portion of the inter-insulating layer 150 can be formed on the upper surface of the drain electrode DE exposed through the first contact hole H1.

Then, the photosensitive pattern 155 is removed from the inter-insulating layer 150 through the strip process.

Referring to FIG. 8F, a second transparent conductive layer is formed on the inter-insulating layer 150. The second transparent conductive layer is patterned by a patterning process so as to form the pixel electrode PE on the inter-insulating layer 150. The pixel electrode PE makes contact with the drain electrode DE through the first and second contact holes H1 and H2.

The black matrix 170 shown in FIG. 7 is formed on the pixel electrode PE so as to correspond to the block area. Accordingly, the first substrate 100 is completed.

As described above, the organic insulating layer 140 includes the lower portion LP having a relatively small thickness in the block area BA in which the thin film transistor Tr is formed. Therefore, the thickness of the photosensitive layer 153 used to form the second contact hole H2 through the inter-insulating layer 150 can be reduced. Thus, the resolving power of the photosensitive layer 153 can be improved. As a result, a micro contact hole can be accurately formed and the degree of difficulty of the exposure process can be lowered.

While the inventive technology has been described, it is understood that the present invention should not be limited to these exemplary embodiments but various changes and modifications can be made by one ordinary skilled in the art within the spirit and scope of the present invention as hereinafter claimed.

What is claimed is:

1. A liquid crystal display (LCD) comprising:
a first substrate;
a second substrate facing the first substrate; and
a liquid crystal layer interposed between the first and second substrates,
wherein the first substrate comprises:
a first insulating substrate;
a thin film transistor (TFT) disposed on the first insulating substrate and including a drain electrode;
an insulating layer covering the TFT and comprising upper and lower portions having different heights, wherein the insulating layer has an opening formed through the lower portion so as to expose the drain electrode;
a reference electrode disposed on the insulating layer;
an inter-insulating electrode covering the reference electrode; and
a pixel electrode disposed on the inter-insulating layer and electrically connected to the drain electrode through the opening.

2. The LCD of claim 1, wherein the reference electrode is further formed over the upper and lower portions.

3. The LCD of claim 2, wherein the reference electrode exposes at least part of the drain electrode.

4. The LCD of claim 1, further comprising a protective layer disposed under the insulating layer so as to cover the TFT, wherein the protective layer comprises a first contact hole formed therethrough so as to expose at least part of the drain electrode.

5. The LCD of claim 4, wherein the inter-insulating layer substantially covers the reference electrode and has a second contact hole formed therethrough so as to expose the part of the drain electrode.

6. The LCD of claim 5, wherein the second contact hole is disposed in the opening.

7. The LCD of claim 6, wherein the second contact hole has a size and a width less than that of the opening.

8. The LCD of claim 7, wherein the first contact hole has a width corresponding to the size and width of the second contact hole.

9. The LCD of claim 7, wherein the size and width of the first contact hole corresponds to the size and width of the opening.

10. The LCD of claim 5, wherein the pixel electrode directly contacts the drain electrode through the first and second contact holes.

11. The LCD of claim 1, wherein the first substrate further comprises:
a color filter layer including a plurality of color pixels; and
a black matrix formed between the color pixels,
wherein the lower portion and opening are formed in an area in which the black matrix is formed when viewed in a plan view.

12. The LCD of claim 1, wherein the second substrate further comprises:
a second insulating substrate facing and connected to the first insulating substrate;
a color filter layer disposed on the second insulating substrate and including a plurality of color pixels; and
a black matrix disposed between the color pixels, wherein the lower portion and the opening are disposed in an area in which the black matrix is formed when viewed in a plan view.

13. A method of manufacturing a liquid crystal display (LCD) that comprises a first substrate, a second substrate facing the first substrate, and a liquid crystal layer interposed therebetween, the method comprising:
forming a first substrate, comprising:
forming a thin film transistor (TFT) including a drain electrode on a first insulating substrate;
forming an organic insulating pattern that i) covers the TFT and ii) comprises upper and lower portions having different heights, wherein the lower portion is formed at least over the drain electrode;
forming a reference electrode over the organic insulating pattern;
etching the organic insulating pattern using the reference electrode as a mask so as to form an insulating layer having an opening formed therethrough,
wherein the opening exposes the drain electrode;
forming an inter-insulating layer so as to cover the reference electrode; and
forming a pixel electrode over the inter-insulating layer such that the pixel electrode is electrically connected to the drain electrode through the opening.

14. The method of claim 13, further comprising forming a first inorganic insulating layer covering the TFT before forming the TFT.

15. The method of claim 14, wherein the forming of the organic insulating pattern comprises:
forming a photosensitive organic insulating layer over the first inorganic insulating layer; and
patterning the photosensitive organic insulating layer through an exposure process using a halftone mask so as to form the organic insulating pattern including the upper and lower portions.

16. The method of claim 15, wherein the forming of the inter-insulating layer comprises:
forming a second inorganic insulating layer over the reference electrode and the organic insulating pattern;
forming a photosensitive pattern having an opening hole formed therethrough on the second inorganic insulating layer; and
etching the first and second inorganic insulating layers using the photosensitive pattern as a mask so as to form first and second contact holes respectively through the first and second inorganic insulating layers, wherein the first and second contact holes expose at least part of the drain electrode.

17. The method of claim 15, wherein the first inorganic insulating layer is etched so as to form a protective layer having a first contact hole formed therethrough, wherein the first contact hole corresponds to the opening when the organic insulating pattern is etched using the reference electrode as a mask.

18. The method of claim 17, wherein the forming of the inter-insulating layer comprises:
forming a second inorganic insulating layer over the reference electrode and the organic insulating pattern;
forming a photosensitive pattern having an opening hole formed therethrough over the second inorganic insulating layer; and
etching the second inorganic insulating layer using the photosensitive pattern as a mask so as to form a second contact hole through the second inorganic insulating layer such that at least part of the drain electrode is exposed through the second contact hole.

19. The method of claim 18, wherein the second contact hole is formed in the opening.

20. The method of claim 19, wherein the second contact hole has a size and a width less than that of the opening.
